(19) United States
(12) Patent Application Publication
(10) Pub. No.: US 2012/0295139 A1
(43) Pub. Date: Nov. 22, 2012

(54) SYSTEM FOR ENERGY STORAGE AND METHOD FOR CONTROLLING THE SAME

(76) Inventors: Young Hak Jeong, Gyeonggi-do (KR); Yong Wook Kim, Gyeonggi-do (KR); Hyun Chul Jung, Gyeonggi-do (KR); Bae Kyun Kim, Gyeonggi-do (KR)

(21) Appl. No.: 13/456,177

(22) Filed: Apr. 25, 2012

(30) Foreign Application Priority Data
May 16, 2011 (KR) 10-2011-0045734

(51) Int. Cl. H01M 10/48

(52) U.S. Cl. 429/50; 429/61

(57) ABSTRACT

Disclosed herein are a system for energy storage may include: a unit cell package in which the plurality of unit cells are connected in series and/or in parallel; an input/output terminal connected with the unit cell package to supply energy to the unit cell package or output energy stored in the unit cell package; an interruption switch connected between the unit cell package and the input/output terminal to connect or interrupt the unit cell package and the input/output terminal with and from each other; a slave connected with the plurality of unit cells and/or the unit cell package to monitor voltages of the plurality of unit cells and/or a voltage of the unit cell package; and a master connected with the slave to receive information monitored by the slave and generate a signal for controlling the slave and the interruption switch in accordance with the monitored information.

### CROSS REFERENCE(S) TO RELATED APPLICATIONS

This application claims the benefit under 35 U.S.C. Section 119 of Korean Patent Application Serial No. 10-2011-0045734, entitled “System for Energy Storage and Method for Controlling the Same” filed on May 16, 2011, which is hereby incorporated by reference in its entirety into this application.

### BACKGROUND OF THE INVENTION

1. Technical Field

The present invention relates to a system for energy storage and a method for controlling the same.

2. Description of the Related Art

Stable supply of energy has become a primary factor in various electronic appliances such as telecommunication devices. In general, this function is performed by a battery. In recent years, as weight of portable apparatuses increases, a secondary battery capable supplying energy to the apparatuses while charging and discharging are repeated at thousands to tens of thousands of times or more has become a general trend.

Meanwhile, a representative example of the secondary battery is a lithium ion secondary battery. The lithium ion secondary battery can stably supply power for a long time in spite of a small size and a light weight due to high energy density, but an instant output is low due to low power density, a long time is required for charging, and the life-span depending on charging and discharging is also short at approximately thousands of times.

In order to complement the uppermost limit of the lithium ion secondary battery, a device called an ultracapacitor or a supercapacitor which has become the conversation topic in recent years has gotten the spotlight as a next-generation energy storage device due to a high charging/discharging speed, high stability, and an environmental friendly characteristic. The ultracapacitor or supercapacitor is lower in energy density than the lithium ion secondary battery, but tens to hundreds times or more higher than the lithium ion secondary battery in power density, at hundreds of thousands of times or more in the charging/discharging life-span, and very high in the charging/discharging speed to be completely charged in several seconds.

A general supercapacitor is constituted by an electrode structure, a separator, and an electrolyte solution. The supercapacitor is driven by using an electrochemical mechanism to selectively adsorb carrier ions in the electrolyte solution to the electrode as a principle by applying power to the electrode structure. Presently, representative supercapacitors include an electric double layer capacitor (EDLC), a pseudo capacitor, and a hybrid capacitor.

The electric double layer capacitor is a supercapacitor that uses an electrode made of activated carbon and uses electric double layer charging as a reaction mechanism. The pseudo capacitor is a supercapacitor that uses a transition metal oxide or a conductive polymer as the electrode and uses pseudo-capacitance as the reaction mechanism. In addition, the hybrid capacitor is a supercapacitor having an intermediate characteristic of the electric double layer capacitor and the pseudo capacitor.

The battery, the secondary battery, and the capacitors as energy storages are used to drive various electric application products and a voltage which each of cells can supply is low as several volts, and as a result, the battery, the secondary battery, and the capacitors modularization of connecting a plurality of cells in series is required to use the secondary battery, and the capacitors as an energy source for apparatuses requiring high voltage.

Further, at the time of connecting the unit cells in series and using the unit cell as the energy source, when the cells operate inheterogeneously, the life-span of the module itself is rapidly reduced and the apparatus may be damaged due to an overvoltage or the apparatus cannot operate normally due to a low voltage, and as a result, means for controlling the unit cell to perform charging and discharging operations within a stable range.

Meanwhile, technologies of detecting and monitoring the voltage of each cell in order to control stable charging and discharging of the plurality of unit cells and interrupting power supplied to a corresponding cell when the detected voltage value is higher than a reference value are presented.

However, although the unit cells can be stabilized with the related arts, there is a limit in stabilizing a unit cell package level in which the plurality of unit cells are connected in series.

When a unit cell package is overcharged or overheated, the performance of the unit cell package itself and the performance of the entirety of an energy storage system including the unit cell package deteriorate and the performance of other system receiving energy from the energy storage system including the unit cell package may also deteriorate.

Accordingly, a demand for a technology capable of stably operating the unit cell package and the entire energy storage system including the unit cell package increases.

### SUMMARY OF THE INVENTION

An object of the present invention is to provide a system for energy storage and a method for controlling the same that improve reliability and stability.

According to an exemplary embodiment of the present invention, there is provided a system for energy storage including a plurality of unit cells storing or outputting energy including: a unit cell package in which the plurality of unit cells are connected in series and/or in parallel; an input/output terminal connected with the unit cell package to supply energy to the unit cell package or output energy stored in the unit cell package; an interruption switch connected between the unit cell package and the input/output terminal to connect or interrupt the unit cell package and the input/output terminal with and from each other; a slave connected with the plurality of unit cells and/or the unit cell package to monitor voltages of the plurality of unit cells and/or a voltage of the unit cell package; and a master connected with the slave to receive information monitored by the slave and generate a signal for controlling the slave and the interruption switch in accordance with the monitored information.

Further, the system may further include a host connected with the master to receive the monitored information and generate a signal for controlling the master.

In addition, the system may further include: a bypass resistor connected to each of the plurality of unit cells in parallel; and a bypass switch connecting or interrupting the bypass resistor and the unit cell with and from each other.

In this case, the slave may control on/off of the bypass switch.

Meanwhile, the interruption switch may include a mechanical switch which is arbitrarily cut off when an output over a threshold value is applied.

Further, the interruption switch may include a programming switch which is turned on/off by receiving the control signal generated from the master.

In addition, the interruption switch may include: a programming switch which is turned on/off by receiving the control signal generated from the master; and a mechanical switch which is arbitrarily cut off when the output over the threshold value is applied.

In this case, the programming switch may be connected with the unit cell package and the mechanical switch may be connected with the programming switch.

Further, the interruption switch includes the programming switch which is turned on/off by receiving the control signal generated from the master based on the predetermined threshold value, and the threshold value is controlled by the host.

Meanwhile, the slave may monitor a temperature instead of the voltages of the plurality of unit cells and/or the voltage of the unit cell package or monitor both the voltage and temperature of the plurality of unit cells and/or the unit cell package.

According to another exemplary embodiment of the present invention, there is provided a method for controlling an energy storage system with a unit cell package including a plurality of unit cells storing or outputting energy, which are connected with each other in series, including: monitoring voltages values of the plurality of unit cells and/or a voltage value of the unit cell package; interrupting a path for supplying energy to the unit cell package or outputting energy stored in the unit cell package to the outside when the monitored voltage values are over a threshold value; and reconnecting the path when the monitored voltage values are equal to or less than the threshold value.

In this case, instead of monitoring the voltages values of the plurality of unit cells and/or the voltage value of the unit cell package, a temperature value of the unit cell package may be monitored or both the voltage value and the temperature value of the unit cell package may be monitored.

### BRIEF DESCRIPTION OF THE DRAWINGS

FIG. 1 is a diagram schematically showing a system for energy storage according to an exemplary embodiment of the present invention.

FIG. 2 is diagram schematically showing one main part of the system for energy storage according to the exemplary embodiment of the present invention.

FIG. 3 is diagram schematically showing another main part of the system for energy storage according to the exemplary embodiment of the present invention.

FIGS. 4 to 7 are diagrams schematically showing modified examples of FIG. 3.

FIG. 8 is diagram showing a part of a method for controlling an energy storage system according to an exemplary embodiment of the present invention.

FIG. 9 is diagram showing another part of the method for controlling an energy storage system according to the exemplary embodiment of the present invention.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. Rather, these embodiments may be provided so that this disclosure will be thorough and complete, and will fully convey the scope of the invention to those skilled in the art. Like reference numerals in the drawings denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, constitution and operation of the present invention will be described in more detail with reference to the accompanying drawings.

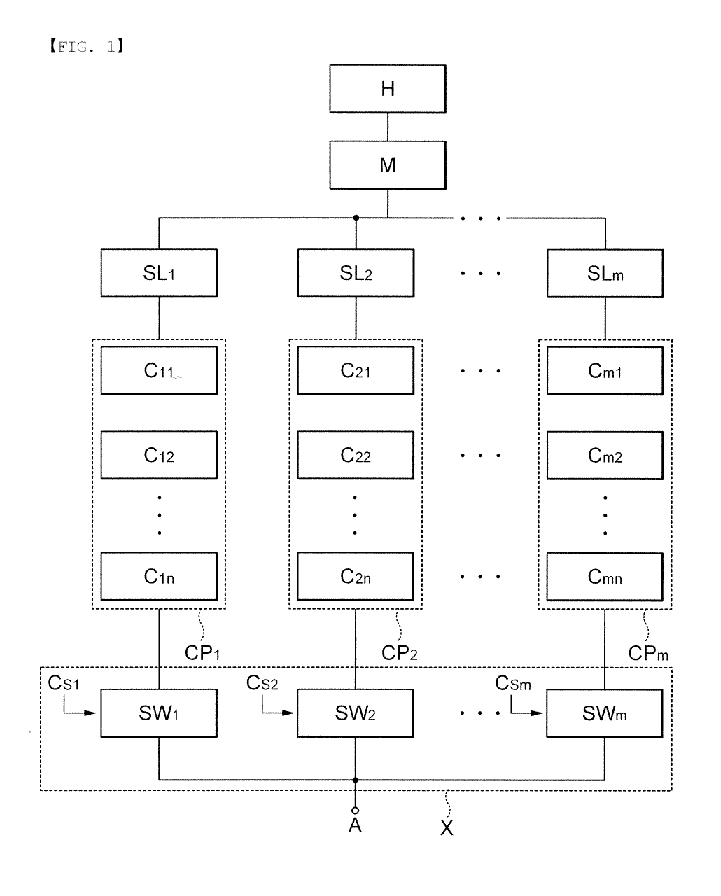

FIG. 1 is a diagram schematically showing a system for energy storage according to an exemplary embodiment of the present invention.

Referring to FIG. 1, the energy storage system according to the exemplary embodiment of the present invention may include a unit cell package CP, an input/output terminal A, an interruption switch SW, a slave SL, and a master M.

The unit cell package CP may be implemented by connecting a plurality of unit cells C in series or in parallel.

The unit cell package CP may be connected to the slave SL and the input/output terminal A. In this case, the interruption switch SW may be connected between the unit cell package CP and the input/output terminal A.

Energy may be supplied to the unit cell package CP through the input/output terminal A or energy stored in the unit cell package CP may be outputted through the input/output terminal A.

The interruption switch SW is provided between the unit cell package CP and the input/output terminal A to connect or interrupt the unit cell package CP and the input/output terminal A to or from each other.

In this case, when the interruption switch SW may be implemented as a mechanical switch SW2 such as a fuse which is arbitrarily cut off when an output over a threshold value is applied between the unit cell package CP and the input/output terminal A.

Further, the interruption switch SW may be implemented as a programming switch SW1 which is turned on/off according to a control signal and may include both a mechanical switch SW2 and the programming switch SW1.

The slave SL may be connected to each of the plurality of unit cells C and/or the unit cell package CP.

In this case, the unit cell package CP may be provided as a module type coupled with the slave SL.

The slave SL may monitor the voltage of the plurality of unit cells C and/or the unit cell package CP. In this case, the slave SL may monitor a temperature instead of the voltage and monitor both the voltage and the temperature.

The master M may be connected with the slave SL. In this case, the plurality of slaves SL may be connected to one master M.

The master M may receive information monitored in the slave SL.

When the slave SL monitors only the voltage of the plurality of unit cells C, the master M may monitor a voltage state of the unit cell package CP by aggregating the voltages of the unit cells C received from the slave SL.

Further, when the slave SL monitors the voltage of the unit cell package CP, the master M may use the voltage state of the unit cell package CP received from the slave SL as it is.

In this case, the master M may generate a control signal for turning off the interruption switch SW when the monitored voltage state of the unit cell package CP is an overvoltage state or an overheat state.

Further, the master M may generate the control signal for turning on the interruption switch SW when the overvoltage or overheat state is deviated by comparing the monitored voltage value or temperature value with a predetermined threshold value.

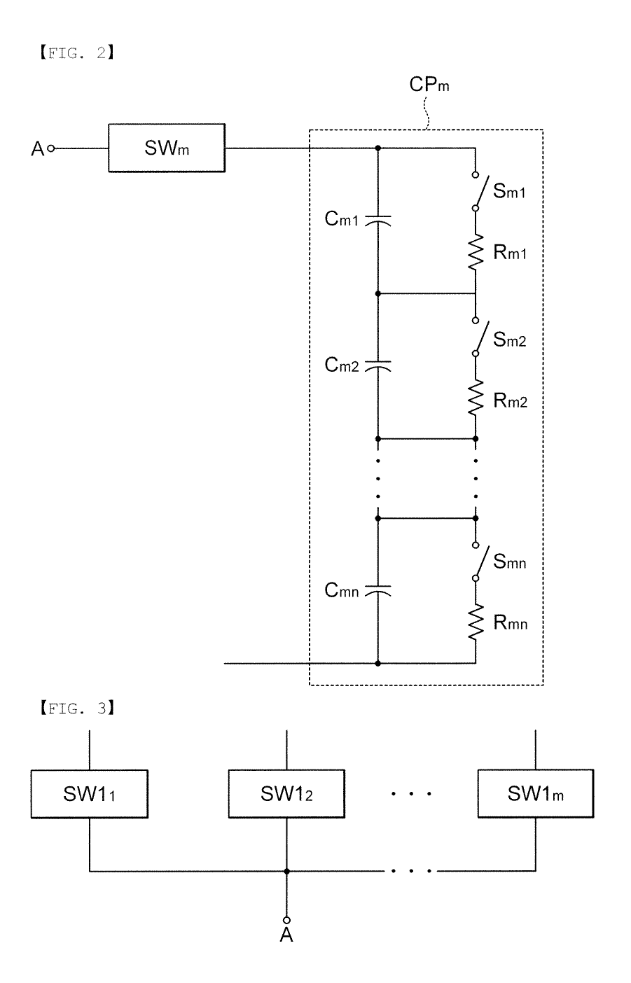

FIG. 2 is diagram schematically showing one main part of the system for energy storage according to the exemplary embodiment of the present invention.

Referring to FIG. 2, the plurality of unit cells C are connected in series to form the unit cell package CP. In this case, a bypass resistor R and a bypass switch S may be provided in each of the unit cells C.

Further, when the voltage or temperature of each of the unit cells C is higher than a normal value, the slave SL generates a control signal for turning on the bypass switch S connected to the corresponding unit cell C to consume the energy of the unit cell C through the bypass resistor R and bypass supplied energy.

Further, when the voltage or temperature of the unit cell C is restored to a normal state, the unit cell C may be again actuated by turning off the bypass switch S.

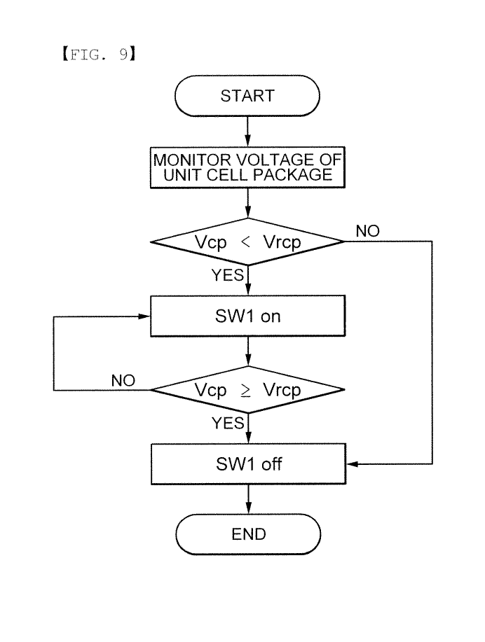

An operational process of the bypass switch S is shown in FIG. 8.

FIG. 3 is diagram schematically showing another main part of the system for energy storage according to the exemplary embodiment of the present invention.

Referring to FIG. 3, the interruption switch SW may be implemented as the programming switch SW1.

The programming switch SW1 may use an IGBT switch.

The programming switch SW1 may be controlled to be turned on/off depending on the control signal.

In this case, the control signal for controlling the programming switch SW1 is generated by the master M to be applied to the programming switch SW1.

The master M compares the monitoring information received from the slave SL with the predetermined threshold value to generate the control signal for turning off the programming switch SW1 between the unit cell package CP which is in the overvoltage state or overheat state and the input/output terminal A.

Further, when the voltage and temperature of the unit cell package CP is restored to a normal range, the master M generates and applies the control signal for turning on the programming switch SW1 to restart the operation of the unit cell package CP.

In this case, the threshold value may be controlled according to a condition inputted or stored in a host H.

An operational process of the interruption switch SW is shown in FIG. 9.

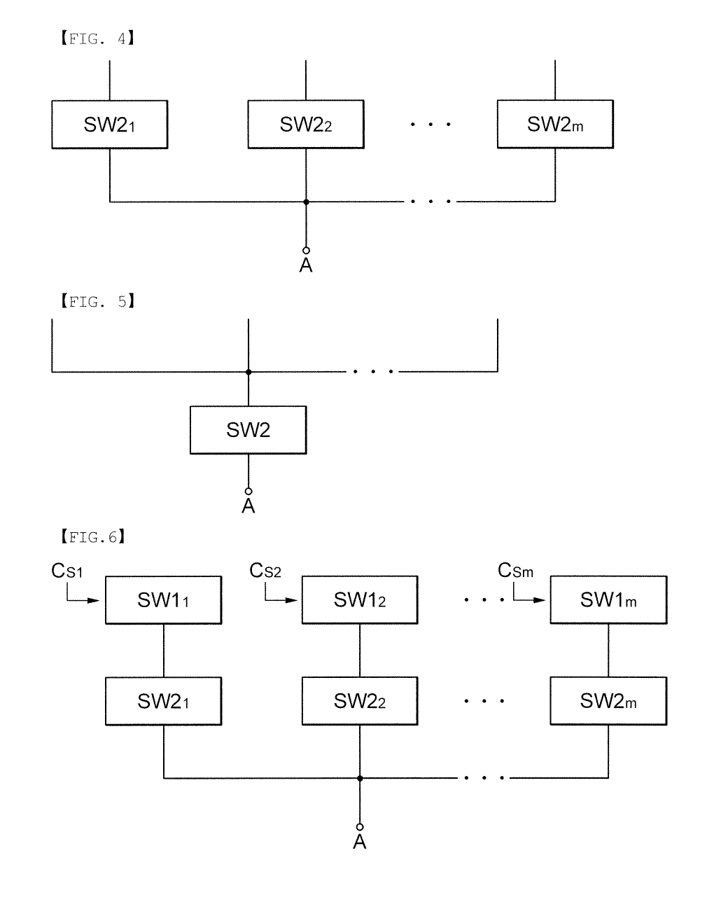

FIGS. 4 to 7 are diagrams schematically showing modified examples of FIG. 3.

Referring to FIGS. 4 and 5, the interruption switch SW may be implemented as the mechanical switch SW2 and as the mechanical switch SW2, the fuse may be used.

The mechanical switch SW2 may be positioned between each unit cell package CP and the input/output terminal A as shown in FIG. 4 and may be positioned between two or more unit cell packages CP and the input/output terminal A as shown in FIG. 5.

As a result, when overvoltage is instantly generated in the unit cell package CP or the plurality of unit cell packages CP or excessive energy is instantly supplied to the unit cell package CP, a path is rapidly interrupted without passing through the slave SL and the master M, thereby preventing failure and minimizing collateral damages.

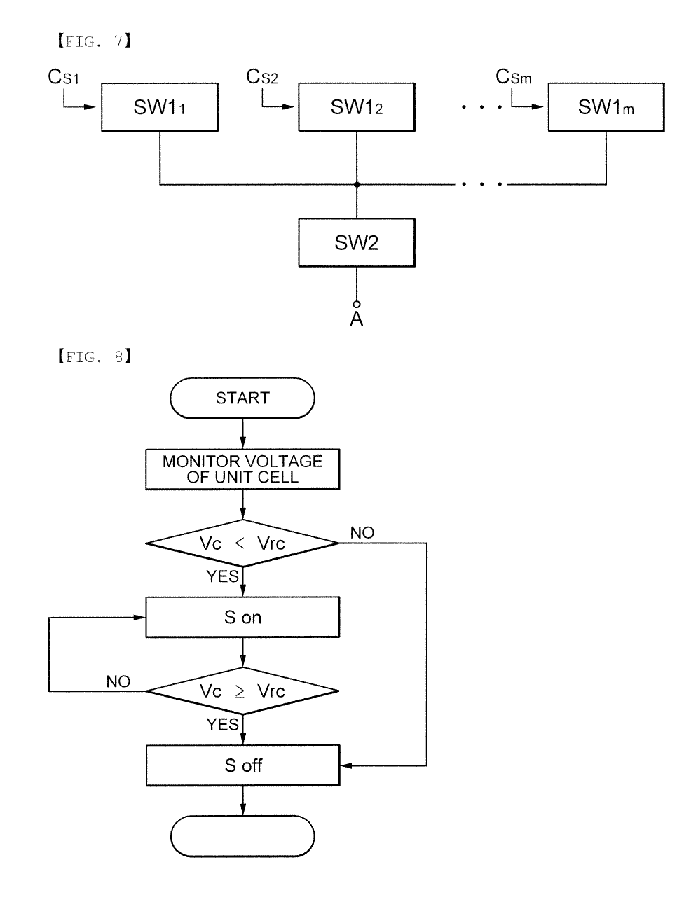

FIGS. 6 and 7 show an example in which both the programming switch SW1 and the mechanical switch SW2 are provided.

The mechanical switch SW2 can protect the system by rapidly interrupting the path when a sudden change occurs, but after the path is once interrupted, the system stops until the mechanical switch SW2 is replaced and the system cannot be automatically restored.

Meanwhile, the programming switch SW1 is interrupted and restored more easily than the mechanical switch SW2, but has a low reaction speed than the mechanical switch SW2, and as a result, it is difficult to rapidly cope with the sudden change.

Therefore, by providing both the programming switch SW1 and the mechanical switch SW2, it is possible to rapidly cope with the sudden change, and interruption and restoration can be easy in other cases.

FIG. 8 is diagram schematically showing a part of a method for controlling an energy storage system according to an exemplary embodiment of the present invention.

Referring to FIGS. 2 and 8, the plurality of unit cells C are connected in series to form the unit cell package CP. In this case, the bypass resistor R and the bypass switch S may be provided in each of the unit cells C.

Further, when the voltage or temperature of each of the unit cells C is higher than the normal value, the slave SL generates the control signal for turning on the bypass switch S connected to the corresponding unit cell C to consume the energy of the unit cell C through the bypass resistor R and bypass supplied energy.

Further, when the voltage or temperature of the unit cell C is restored to the normal state, the unit cell C may be again actuated by turning off the bypass switch S.

Meanwhile, there is a limit in stabilizing the unit cell package CP only by the stabilization technology using the bypass resistor R and the bypass switch S.

FIG. 9 is diagram showing another part of the method for controlling an energy storage system according to the exemplary embodiment of the present invention.

Referring to FIGS. 3 and 9, the interruption switch SW may be implemented as the programming switch SW1 such as an IGBT.

At the time of monitoring the voltage or temperature of the unit cell package CP, by comparing the monitored voltage or temperature of the unit cell package CP with the predetermined threshold value, the programming switch SW1 connected with the unit cell package CP that enters the overcharging or overheat state may be turned off.

Further, when the voltage or temperature of the unit cell package CP is restored to the normal state, the corresponding unit cell package CP may be restarted by turning on the programming switch SW1.

In this case, the control signal for controlling the programming switch SW1 is generated by the master M to be applied to the programming switch SW1.

Further, the threshold value may be controlled according to a condition inputted or stored in the host H.

As a result, in the energy storage system including the plurality of unit cell packages CP, since the unit cell package CP and the input/output terminal A may be connected to or interrupted from each other for each unit cell package CP, reliability of the energy storage system is improved.

Further, since the system can be operated by removing only a unit cell package CP having an abnormal state and using the rest of unit cell packages CP, use efficiency of the system is improved.

In addition, by interrupting or connecting the path with the programming switch SW1, the system can be stably operated by setting threshold values according to various cases and conditions.

As set forth above, according to exemplary embodiments of the present invention, since energy supplied to a unit cell package can be interrupted or an output of the unit cell package can be interrupted by monitoring overcharging or overheating of the unit cell package, a system for energy storage having improved reliability and stability can be provided.

Further, since a slave which is one component of the energy storage system monitors and transmits only states of the unit cells to a master and the master can monitor the state of the unit cell package by aggregating information transmitted from the slave, design flexibility of the slave is improved.

Further, even when the master is connected with an additional host, the host can stably operate the entire energy storage system only by setting simple control value, and as a result, the design flexibility of the host is improved.

The above detailed description exemplifies the present invention. Further, the above contents just illustrate and describe preferred embodiments of the present invention and the present invention can be used under various combinations, changes, and environments. That is, it will be appreciated by those skilled in the art that substitutions, modifications and changes may be made in these embodiments without departing from the principles and spirit of the general inventive concept, the scope of which is defined in the appended claims and their equivalents. Although the exemplary embodiments of the present invention have been disclosed for illustrative purposes, those skilled in the art will appreciate that various modifications, additions and substitutions are possible, without departing from the scope and spirit of the invention as disclosed in the accompanying claims. Therefore, the detailed description of the present invention does not intend to limit the present invention to the disclosed embodiments. Further, it should be appreciated that the appended claims include even another embodiment.

What is claimed is:

1. A system for energy storage including a plurality of unit cells storing or outputting energy, comprising:
a unit cell package in which the plurality of unit cells are connected in series and/or in parallel;
an input/output terminal connected with the unit cell package to supply energy to the unit cell package or output energy stored in the unit cell package;
an interruption switch connected between the unit cell package and the input/output terminal to connect or interrupt the unit cell package and the input/output terminal with and from each other;
a slave connected with the plurality of unit cells and/or the unit cell package to monitor voltages of the plurality of unit cells and/or a voltage of the unit cell package; and
a master connected with the slave to receive information monitored by the slave and generate a signal for controlling the slave and the interruption switch in accordance with the monitored information.

2. The system for energy storage according to claim 1, wherein the slave monitors a temperature instead of the voltages of the plurality of unit cells and/or the voltage of the unit cell package.

3. The system for energy storage according to claim 1, wherein the slave monitors the voltage and temperature of the plurality of unit cells and/or the unit cell package.

4. The system for energy storage according to claim 1, further comprising a host connected with the master to receive the monitored information and generate a signal for controlling the master.

5. The system for energy storage according to claim 1, further comprising:
a bypass resistor connected to each of the plurality of unit cells in parallel; and
a bypass switch connecting or interrupting the bypass resistor and the unit cell with and from each other.

6. The system for energy storage according to claim 5, wherein the slave controls on/off of the bypass switch.

7. The system for energy storage according to claim 1, wherein the interruption switch includes a mechanical switch which is arbitrarily cut off when an output over a predetermined threshold value is applied.

8. The system for energy storage according to claim 1, wherein the interruption switch includes a programming switch which is turned on/off by receiving the control signal generated from the master.

9. The system for energy storage according to claim 1, wherein the interruption switch includes:
a programming switch which is turned on/off by receiving the control signal generated from the master; and
a mechanical switch which is arbitrarily cut off when the output over the predetermined threshold value is applied.

10. The system for energy storage according to claim 9, wherein the programming switch is connected with the unit cell package and the mechanical switch is connected with the programming switch.

11. The system for energy storage according to claim 4, wherein:
the interruption switch includes the programming switch which is turned on/off by receiving the control signal generated from the master based on the predetermined threshold value, and
the threshold value is controlled by the host.

12. A method for controlling an energy storage system with a unit cell package including a plurality of unit cells storing or outputting energy, which are connected with each other in series, comprising:
monitoring voltage values of the plurality of unit cells and/or a voltage value of the unit cell package;
interrupting a path for supplying energy to the unit cell package or outputting energy stored in the unit cell package to the outside when the monitored voltage values are over a predetermined threshold value; and
reconnecting the path when the monitored voltage values are equal to or less than the predetermined threshold value.

13. A method for controlling an energy storage system with a unit cell package including a plurality of unit cells storing or outputting energy, which are connected with each other in series, comprising:
monitoring temperature values of the plurality of unit cells and/or a temperature value of the unit cell package;
interrupting a path for supplying energy to the unit cell package or outputting energy stored in the unit cell package to the outside when the monitored temperature values are over a predetermined threshold value; and
reconnecting the path when the monitored temperature values are equal to or less than the predetermined threshold value.

14. The method for controlling an energy storage system according to claim 12, wherein the threshold value is determined in accordance with a condition inputted into a host connected to a master monitoring the unit cell package.

15. The method for controlling an energy storage system according to claim 13, wherein the threshold value is determined in accordance with a condition inputted into a host connected to a master monitoring the unit cell package.
